(19) United States
(12) Patent Application Publication
(10) Pub. No.: US 2006/0169398 A1
(43) Pub. Date: Aug. 3, 2006

(54) Method and device for automated application of lacquer film on bodywork parts and use of a stretched adhesive strip

(75) Inventors: Uwe Haibistritinger, Lossburg (DE); Bernhard Nordmann, Boeblingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/549,273

(22) PCT Filed: Jan. 16, 2004
(86) PCT No.: PCT/EP04/00286

§ 371 Date: Sep. 13, 2005

(51) Int. Cl. B29C 65/00

(52) U.S. Cl. 156/229

(57) ABSTRACT

A method and device for automated application of lacquer film, which is integrated into a film composite, to a bodywork part using a robot-guided application tool. An adhesive-side protective strip is removed in a tool integrated manner and the stretched film blank is applied to the bodywork part using a doctor above the application point in the presence of a visible protective strip in a tool integrated manner. In order to exclusively use two-layered film composites and therefore simple application tools, the film composite which is individually and disposed on a hard substrate in a forcibly flat manner is received using an adhesive strip which is stored in a tool integrated manner on a roller and which can be subsequently rolled up after use inside the tool in question whereby it can be applied to the film composite by means of a doctor in a tool integrated manner. The transferred lacquer film blank is then applied to the bodywork part after the adhesive side has been uncovered. The adhesive strip is used as a protective strip. The adhesive strip is then removed from the applied lacquer film and can be re-used in a subsequent application process in the application tool. The active working section of the adhesive strip can be automatically renewed inside the tool after it has been used several times.

The invention relates to a method and a device for automated application of lacquer film to bodywork parts. The invention is based here on the applicant's earlier patent application, according to German Offenlegungsschrift DE 102 30 034 A1, which was not published before the priority date. A method considered to be known from this document is reproduced in the precharacterizing clause of claim 1 and a corresponding device is reproduced in the precharacterizing clause of claim 16. The invention also relates to the use of an adhesive strip.

On vehicles, it is often intended for stylistic reasons to cover the surface of the bodywork lying between two neighboring areas of glass with a lacquer film that is black or dark-colored, irrespective of the color of the rest of the car, and often has a high-gloss finish, in order in this way to give the impression of a continuous glass surface at this location. To be precise, the two neighboring vertical frame members of the window frames in the region of the center pillar of the vehicle come into consideration here in particular—but not only these. On vehicles with a lamella roof or glass roof, it is also popular for stylistic reasons for the horizontally lying bodywork strip above the windshield to be provided with a dark-colored lacquer film, in order to create the visual impression of a uniformly continuous area here too. In the case of side application of the lacquer film, it is applied to the frame members of the window frame of the side doors. Since these areas of the bodywork generally represent only narrow strips, the blank of the lacquer film to be applied is also correspondingly shaped in an elongated manner and not particularly large. Since the lacquer film remains on the vehicle during the entire time it is in use, the lacquer film must correspondingly be adhesively attached permanently to the bodywork, account having to be taken of the fact that the side members to be covered in this way are in the direct field of view of the vehicle users, at least when they are getting in, and consequently the requirements for a satisfactory film application are particularly high.

For the automated application method known from the earlier patent application cited at the beginning (DE 102 30 034 A1), a three-layer film composite suitable for the purpose is

proposed, bearing an area-covering protective film or protective paper on each of both sides of the actual lacquer film blank. For the machine handling of the elongated film composite, a so-called tab is attached to both its ends, i.e. the protective film strips overhang at the ends. At these overhanging tabs, the film composite is grasped by means of controllable flat suction grabbers of a robot tool from a flat readiness position, the suction grippers being tilted out of the take-up plane after taking up the film composite. The tilting away of the suction grippers allows the film composite, which is kept stretched and is to be applied to the bodywork by a doctor knife, to be pressed out from the take-up plane in a V-shaped manner, without the contact area on the suction grippers being partially exposed. In addition, a second, separate tab, which projects beyond the first tab, is provided at one end of the film composite for the adhesive-side protective film. Using this further tab, the adhesive-side protective film can be removed from the film composite, i.e. the adhesive side of the lacquer film can be exposed, in an automated manner before the actual lacquer film application.

Although, to the knowledge of the applicant, it is possible for the first time with the technology according to the earlier patent application DE 102 30 034 A1 to apply lacquer films to bodywork parts in an automated manner, which apart from the advantage of providing relief from strenuous and monotonous manual work has the further, major advantage of lacquer film application that is always positionally accurate and free from bubbles and folds, it has been found on the other hand that the earlier technique still has the following disadvantages:

The required robot tools are complex and correspondingly susceptible to requiring maintenance, which is reflected in investment and maintenance costs. Since, because of the multiplicity of application locations on a vehicle model and the requirement of a reserve tool for each application location, a relatively large number of robot tools are simultaneously required, the expenditure is correspondingly higher.

Conversion of the robot tool to changed formats of the lacquer film blank is only possible to a very restricted extent. The robot tools therefore could not be used in a wider range of film formats.

A vacuum in the robot tool for handling the lacquer film composite is not entirely unproblematical from aspects of construction and control technology (large line cross sections, voluminous valves), which restricts the robot tool in the freedom of movement.

The prefabricated lacquer film composites must have on both opposite narrow sides relatively long, three-ply “tabs”, which have the same ply structure as the actual lacquer film blank, to be specific (from bottom to top) an adhesive-side protective strip, a lacquer film and an outer protective strip. As a result, each individual lacquer film composite is relatively expensive, which is reflected in a relatively high material price.

The pulling-off of the outer protective strip after the application of the lacquer film and the depositing of this protective strip in a waste container takes time and adversely affects the cycle time. Furthermore, the rolling-up protective strip represents very voluminous waste, which takes up considerable space in the application station.

The object of the invention is to improve the method and the corresponding device of the generic type that are taken as a basis to the extent that these disadvantages are avoided. It is therefore intended by the invention that

more simple, and consequently less costly, lacquer film composites can be processed in an automated manner,

the robot tools can be made more simple, and consequently less costly,

conversions of the robot tools to different lacquer film formats are possible without any problem,

the robot tools are not restricted in their mobility by voluminous peripheral components and

the volumes of the protective strips occurring as waste are reduced.

Taking the application method and the corresponding device of the generic type as a basis, this object is achieved according to the invention by the characterizing features of claim 1 (method) and by the characterizing features of claim 16 (device). According to the invention, furthermore, the use of a virtually endless, wound-up adhesive strip as an outer protective strip is proposed for the automated taking-up and application of self-adhesive lacquer film blanks to bodywork parts (claim 27).

According to the latter, the upper film composite is handled by an adhesive strip located in the robot tool. A piece of adhesive strip that is kept stretched in the take-up plane of the application tool can be used repeatedly and can be easily renewed as and when required. In an expedient way, the adhesive strip is pulled from a supply roller secured in the tool, passed through the take-up plane of the robot tool over a pair of deflection rollers and wound up after use on a take-up roller likewise secured in the tool. This adhesive strip not only undertakes the secure holding of the lacquer film during the film application, but also replaces the outer protective strip previously attached on the outer side of the lacquer film composite. This makes it possible to dispense with voluminous vacuum hoses and vacuum valves, restricting the mobility. There are no longer any complex, tiltable suction grippers, which adversely affect the convertibility of the application tool to other film formats. With the adhesive strip, any desired formats of lacquer films can be readily taken up and securely handled. The novel, now only two-ply, lacquer film composite is also of a simpler form than previously and the lacquer film is transferred from the adhesive strip into the application tool directly on its exposed visible side. Since a number of clean lacquer films can be taken up by the adhesive strip one after the other, the adhesive strip need not be renewed after each application operation; rather, renewal after repeated use is sufficient. In the case of a virtually endless adhesive strip, the renewal may take place at intervals, i.e. by displacing the adhesive strip by an entire length of lacquer film after a specific number of application operations. Instead, the stretched adhesive strip may for example also be renewed by an incremental advancement of the adhesive strip by merely a small fraction of the length of the lacquer film after each application operation. The consumption of protective film is therefore much less than in the case of the old technology and the consumed protective film in the case of a virtually endless adhesive strip is wound up inside the robot tool in a space-saving manner. To this extent, no voluminous waste is created. Moreover, the two-ply lacquer film composite now only has at one end of the adhesive-side protective strip a tab by which the protective strip can be pulled off the lacquer film blank; the film composite is therefore also made simpler in this respect than the case of the older technology.

Further expedient refinements of the invention can be taken from the subclaims; moreover, the invention is further explained below on the basis of various exemplary embodiments that are represented in the drawings, in which:

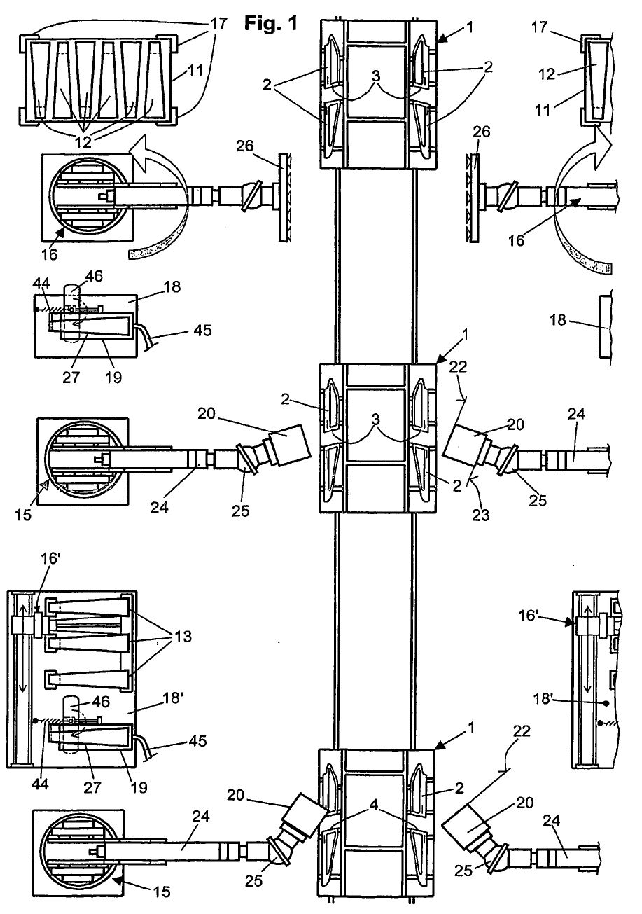

FIG. 1 shows a plan view of a workstation for the automated application of self-adhesive lacquer film to the frame members in the region of the center pillar of vehicle side doors,

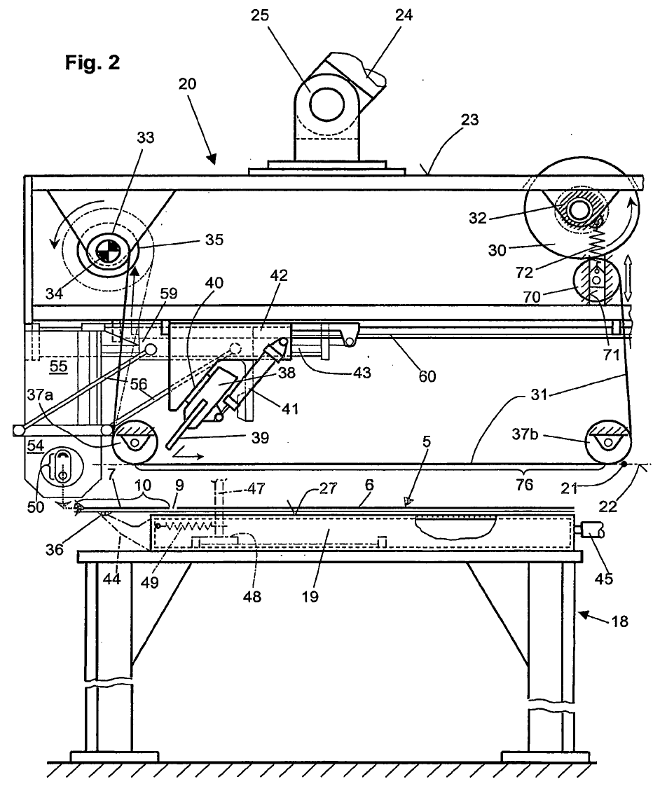

FIG. 2 shows a view of a first exemplary embodiment of an application tool of a robot of the workstation as shown in FIG. 1 shortly before taking over an individually presented film composite,

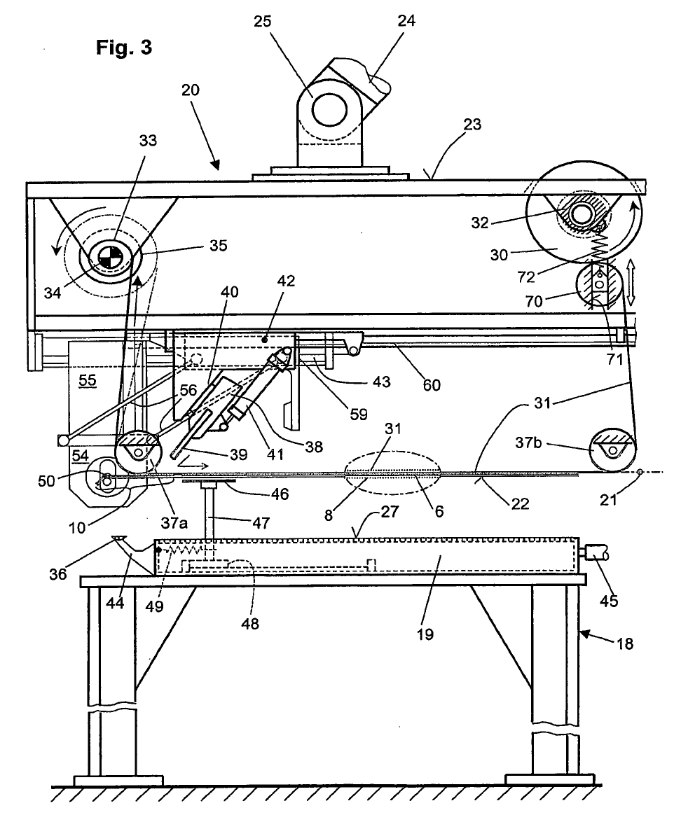

FIG. 3 shows the application tool as shown in FIG. 2 in the phase after it has taken up the film composite and the adhesive-side protective strip is to be pulled off,

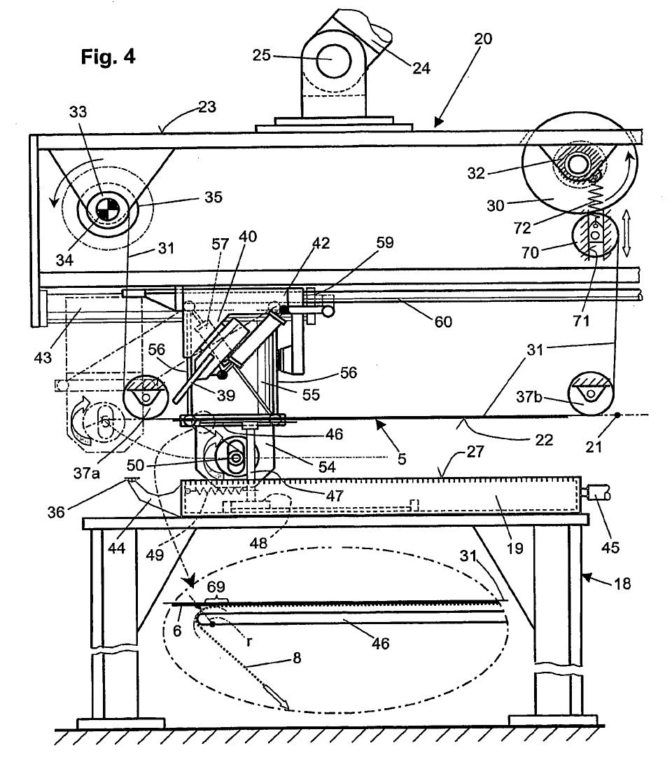

FIG. 4 shows the application tool as shown in FIG. 3 during the pulling-off of the adhesive-side protective strip from the film composite,

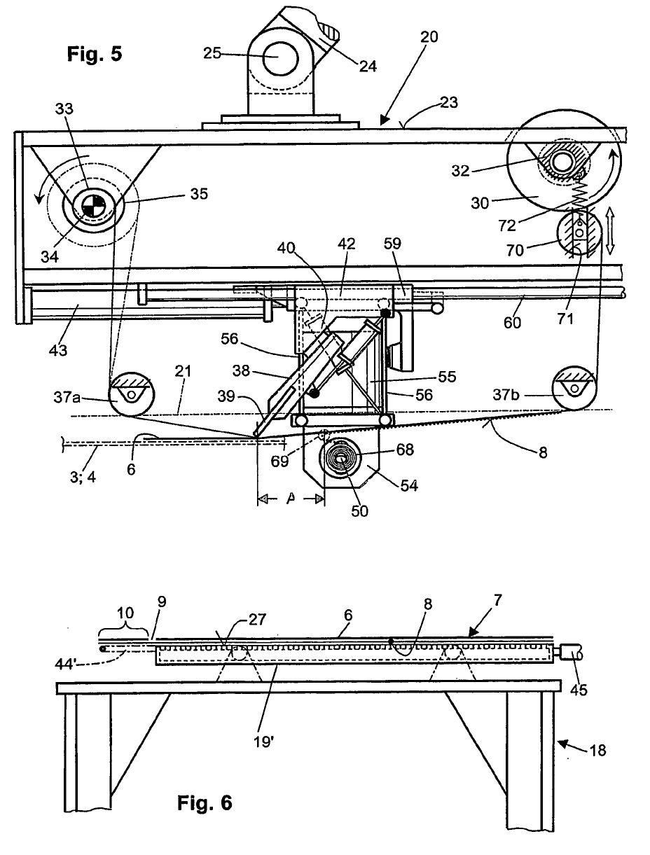

FIG. 5 shows the application tool as shown in FIG. 2 or 3 during the application of the lacquer film to the bodywork,

FIG. 6 shows an exemplary embodiment, modified in comparison with the preparation table as shown in FIG. 2, 3 or 4, of such a table with laterally held suction boxes, which can be passed under, and with another holding arm for carrying the tab of the adhesive-side protective strip,

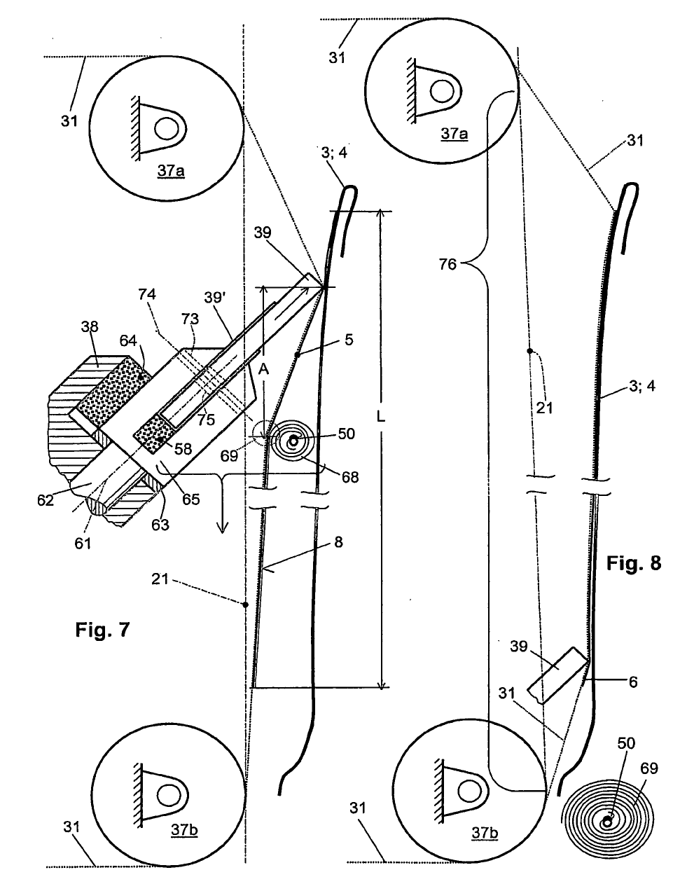

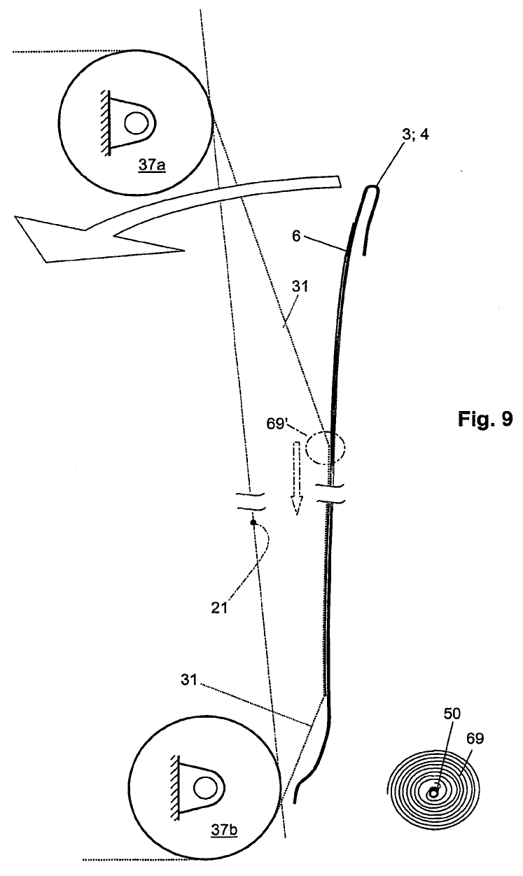

FIGS. 7, 8 and 9 show three different phases in the application of the lacquer film, to be precise the beginning (FIG. 7) and end (FIG. 8) of the actual application operation and the pulling-off of the adhesive strip, remaining in the tool and used as an outer protective strip, from the applied lacquer film (FIG. 9),

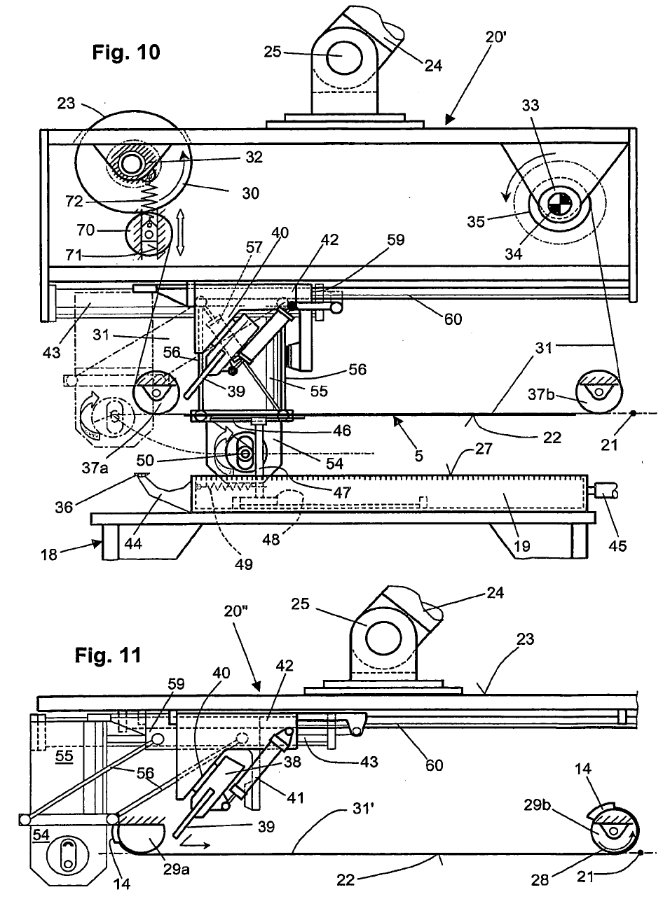

FIG. 10 shows a view of a second exemplary embodiment of an application tool, in which the supply roller is arranged on that side of the piece of adhesive strip that is stretched in the take-up plane on which the doctor knife also begins its working stroke, the application tool being shown—as in FIG. 2—in a phase shortly before the takeover of a presented film composite,

FIG. 11 shows a view of a further exemplary embodiment of an application tool, in which an endless piece of adhesive strip is stretched between two clamping cylinders in the take-up plane, which piece has to be separately and externally exchanged,

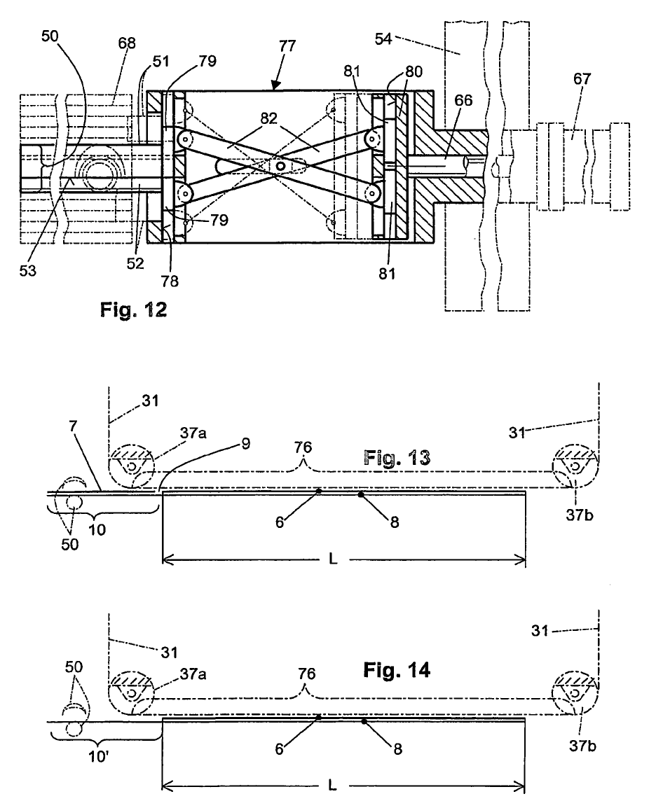

FIG. 12 shows an enlarged individual representation of the long-nose pliers of the application tool represented in the figures, with symmetrically movable nose parts for grasping and handling the tab of the film composite and for winding up the protective strip, and

FIGS. 13 and 14 show two different exemplary embodiments of film composites with and without lacquer film in the region of the end tab.

Firstly, the overall view of an application station according to FIG. 1 is to be discussed in more detail, but is merely to be regarded as one exemplary embodiment along with many other conceivable variants. The side doors 2 of a vehicle body are to have lacquer film adhesively attached to them in an automated manner on the frame members 3 and 4 that are assigned to the center pillar. For this purpose, the side doors, mounted in a positionally defined manner on transporting racks 1, are conveyed one after the other on guide rails through the application station, the transporting racks, and with them the side doors, being stopped in the region of the application robots and aligned and fixed in a positionally defined manner. Set up on both sides of the conveying line are freely programmable industrial robots for the automated implementation of the application method. Only the application robots 15 are provided with an application tool 20 on their working arm 24 or hand joint 25. These tools in each case take up from the fixed table 18 or 18′, shown in two exemplary embodiments, a film composite that is presented there, and apply the lacquer film blank contained therein to the frame members 3 or 4, respectively.

The method according to the invention for automated application of self-adhesive lacquer film to bodywork parts presupposes that the self-adhesive lacquer films to be applied are prefabricated in blanks 6 and that these blanks are formed appropriately for handling. In order to allow the prefabricated lacquer film blanks 6 to be transported and handled in an automated manner, they must be respectively provided on their adhesive side with a sticking, but easily removable, protective strip 8, that is to say be contained in a two-ply film composite. Furthermore, the tab 10, 10′ projecting beyond the usable length L of the lacquer film blank 6 on the adhesive-side protective strip is important for automated application of the lacquer film blank. Such a tab is necessary in the present case merely in the region of a single narrow side at the end of the blank, in order to allow the adhesive-side protective strip to be pulled off. For the handling of the film composite as a whole in a way that is appropriate for automation, however, no further tabs are required.

Represented in the drawings (FIGS. 13 and 14) are two different embodiments of film composites 5 and 5′, which differ merely by the single, mentioned tab 10 or 10′, respectively. The tab is in both cases a component part of the adhesive-side protective strip which adjoins the usable length L of the lacquer film blank 6. Like the remaining region of the adhesive-side protective strip 8, the tab 10 as shown in FIG. 13 is likewise covered by a piece of lacquer film 7, although a narrow interruption 9 between the usable part of the lacquer film blank 6 and the waste piece 7 is provided at the transitional region. By contrast, the tab 10′ of the film composite as shown in FIG. 14 does not have such a waste piece of lacquer film on the upper side. The advantage of the film composite as shown in FIG. 13 (with waste piece 7) is a thickness that is uniform over the entire length of the film composite, so that these film composites can be stacked well. The advantage of the film composite as shown in FIG. 14 (without waste piece 7) is better flexibility of the tab, so that it can be wound better in the initial phase.

In connection with the technique according to the invention of taking over and handling the film composites in or by the application tool, the film composite must be presented on the table 18, 18′ on a hard, flat base 27, and be securely held on it so as to lie flat. Therefore, the film composites cannot be offered in a stack, but must first be individually separated. For this purpose, in the case of the exemplary embodiment represented at the top in FIG. 1, the upper application robots 15 must also be assigned a presentation robot 16, the working arm of which is provided with a correspondingly formed suction gripper 26. The presentation robot in each case removes a film composite from the delivery container 11 and places it in a positionally exact manner onto the rotationally fixed presentation table 18. The dimensionally stable delivery container contains a number of stacks 12 of film composites, which are fixed in it in a positionally exact manner by corresponding internal fittings. Furthermore, on account of station-side securing stops 17, the delivery container is set up in a positionally defined manner in the working region of the presentation robot. As a result and on account of the number of film composites per stack 12, which is prescribed and included in the programming of the robot, it is possible for the presentation robot to work the delivery container 11 empty of its own accord and to present the film composites to the application robots one after the other in the same position. It is then merely required at relatively great time intervals to exchange the delivery container that has been worked empty for a full one.

Represented in the lower part of FIG. 1 is a more simple device for the individual separation and presentation of film composites, which is integrated on the presentation table 18′.

On this table, a number of compartments 13 are arranged in parallel next to one another, laterally offset in relation to the base 27, for the presentation of an individually separated film composite, which compartments can in each case take relatively large stacks of film composites. This would also make it possible to stock different lacquer films for a production mix. The compartments 13 on the one hand and the base 27 on the other hand are at the same distance as one another from a side edge of the table. Apart from the compartments and the base, a transfer device 16′ with two Cartesian axes of movement is arranged and can be used in each case for removing a film composite from one of the compartments 13 and depositing it on the base 27. For this purpose, a horizontal guide running parallel to the table edge is provided for a carriage with a corresponding movement drive and a vertical guide is provided on the carriage for a flat suction gripper for taking up a film composite. The compartments 13 can take a relatively large number of film composites, so that manual refilling of the same is required only at relatively great time intervals.

The positionally defined presentation of the film composite for takeover by the handling robot can therefore take place in various ways, including ways not even described here, and also in different positions. What is important is firstly that the position of the film composites to be taken over that is precisely defined by mechanical stops or the like does not change during the takeover. In addition, the film composite must rest on a hard, level base, in order that it can be taken over into the application tool by doctor blading by means of a doctor knife integrated in the tool. Therefore, the film composites 5 must be offered individually, and preferably in a horizontal position, to the application tool for takeover. This is so because the two-ply film composites have a tendency, because of the dissimilar plies, to curl up, in particular on account of the different temperature- and/or moisture-dependent elongation of the two plies. Under some circumstances, electrostatic forces acting between the tool-side adhesive strip on the one hand and the presented film composite on the other hand could lead to an unwanted change in position of the film composite.

In order to be able to present the film composite satisfactorily on the table in spite of such a tendency to curl up and in spite of electrostatic forces, the film composite is forcibly held securely in a flat position, which takes place in the case of the exemplary embodiment represented in the figures by the hard base attached on the table 18, 18′ being formed as a suction box 19, which for its part can, via a connection 45, have a vacuum applied to it as and when required, i.e. for holding the composite in place, or have air admitted to it for releasing it. The upper side of the suction box forms the hard level base 27. In order that, when applying the tool-side adhesive strip by the doctor knife to the securely held film composite, edges of bores in the upper wall of the suction box cannot leave an impression on the sensitive lacquer film blank 6 through the adhesive-side protective strip 8, the upper wall of the suction box is only provided with suction bores in the edge region, which lie in the region of the lacquer film that is in any case folded around after the application.

Attached to one end of the suction box or the base is a holding arm 44, which in the case of the exemplary embodiment represented in FIGS. 2 to 5 carries at its free end a small suction bar 36, which can be subjected to a vacuum or have air admitted to it parallel to the suction box. The upper side of the suction bar, where the suction is effective, lies flush with the upper side of the base 27. The extreme end of the tab 10 or 10′ is securely held by the suction bar, whereas the main part of the tab is stretched out freely and is consequently accessible for a gripping tool from above and below and also transversely from the sides. At this point, it should already be mentioned in advance that, in the case of the more simple variant of the suction box that is represented in FIG. 6, the holding arm 44′ is merely formed as a piece of wire angled away in an L-shaped manner, on the one, transversely lying element of which the extreme end of the tab loosely rests.

Before the method according to the invention for application of the self-adhesive lacquer film is to be discussed, first the application tool 20 shown in different phases in FIGS. 2 to 5 is to be presented in its significant details.

The application tool that is shown in various exemplary embodiments 20 (FIGS. 2-5), 20′ (FIG. 10) and 20″ (FIG. 11) is fastened on its rear side 23 to the hand joint 24 of the robot arm, whereas its working side 22 is arranged on the opposite side of the application tool. Attached on the working side, parallel to one another and at a distance which is greater than the usable length L of the lacquer film blank 6 are two deflection rollers 37a and 37b or clamping cylinders 29a, 29b for adhesive strip 31, 31′, the common outer tangent of which lies in the take-up plane 21. Apart from a certain possibility of adjustment with regard to parallelism and the possibility for setting the distance for the purpose of adaptation to a different film format, the two deflection rollers or clamping cylinders are mounted in a stationary manner in the application tool. The two deflection rollers have the effect of stretching a piece 76 of a virtually endless adhesive strip in the working plane with the adhesive side facing downward. The application tool 20″ with the clamping cylinders is to the briefly discussed separately further below.

A supply roller 30 and a take-up roller 33 for new adhesive strip and used adhesive strip, respectively, are mounted between the rear side and the working side of the application tool 20, 20′—likewise fixed in place therein—in such a way that they can be exchanged quickly as and when required. The take-up roller 33 is fitted in a rotationally fixed manner on a drive shaft 34, which can be driven with a presettable torque by a drive motor 35, its drive being formed altogether in such a way that, even at a standstill, the take-up roller 33 can be driven in the sense of winding up the adhesive strip and can also be braked completely to a standstill. The supply roller 30 is fitted in a rotationally fixed manner on a braking shaft, which can be braked by a brake 32 with a predeterminable braking torque.

With regard to the possibility of the adhesive strip laterally running askew through the take-up plane, which is encouraged in particular by the doctor blading of the lacquer film blank, the take-up roller is mounted in the application tool in an axially displaceable manner, so that it is able to follow an adhesive strip that under some circumstances is displaced laterally. For the automation of an orderly winding-up of the used adhesive strip, the position of the side edge of the adhesive strip is detected in the end region of the take-up plane lying turned toward the take-up roller. Furthermore, a servomotor-effected side adjustment of the take-up roller is to be provided, activated in dependence on the detected side offset of the used adhesive strip. This allows the used adhesive strip to be wound up in an orderly manner.

In order to be able, as and when required, also to pull off small lengths of adhesive strip smoothly from the supply roller, a compensating roller 70 is arranged in the run-off of the adhesive strip from the supply roller and is wrapped around at approximately 90°. The compensating roller, which is mounted in a radially displaceable manner in relation to the supply roller in a guide 71, can unforcibly follow the changes in diameter of the supply roller which the latter undergoes in dependence on the use of adhesive strip. The compensating roller bears with a certain prestress against the outer circumference of the supply roller. For this purpose, the compensating roller is stressed in the direction of the supply roller by means of a spring 72.

On account of the compensating roller 70, even relatively small lengths of adhesive strip can be smoothly pulled off downward. For the case in which the piece 76 stretched in the take-up plane 21 is to be held unyieldingly, or in such a way that it yields only after overcoming a specific limiting force, not only the supply roller itself and the take-up roller 33 are able to be braked with a higher securing force, but under some circumstances the compensating roller 70 can also be fixed by a brake within its radial displaceability 71, which however is not indicated in the drawing.

The strand of the adhesive strip running from the compensating roller is guided onto the first deflection roller 37b and is deflected by it into the take-up plane 21. After running through the take-up plane, the second deflection roller 37a is reached, which deflects the adhesive strip to the take-up roller 33. In the piece 76 of the adhesive strip that is stretched in the take-up plane 21, its adhesive side faces downward, which is important for the function of the application tool.

When unwinding adhesive strip from the supply roller, electric charges can be released in the pulled-off adhesive strip and can attract dust particles from the surroundings and allow them to be deposited on the surface, which would be disruptive during the doctor blading. In order to reduce this risk, it is expedient if the compensating roller 70 is superficially electrically conductive and in this respect electrically grounded. It is alternatively or additionally also conceivable to discharge and render harmless an electric charge from the pulled-off adhesive strip by means of a narrow grounded brush of long, soft, electrically conductive fibres.

Also arranged in the application tool alongside the one deflection roller 37a, shown on the left in FIGS. 2 to 5, is a parallel-displaceable gripping tool 50, which is represented on its own in FIG. 12. Further different configurations of gripping tools which could also be used in the present case are graphically represented and described in the already mentioned DE 102 30 034 A1. In the case of two of the gripping tools shown there, it is formed as rotatably mounted long-nose pliers, with which the protective strip 8 grasped at the end can at the same time also be wound up. In the case of two further gripping tools shown and described in DE 102 30 034 A1, it is formed as a rotatably drivable, cross-sectionally D-shaped suction bar, which may likewise serve as a winding core. In each case, the gripping tool is movably mounted and provided with a corresponding movement drive in such a way that, on the one hand, it can be moved up to the take-up plane 21, ready for taking up, alongside the left-hand deflection roller 37a on the start side—starting position. On the other hand, the gripping tool can be moved out of the starting position under the take-up plane 21 into a working plane of the gripping tool and within this working plane parallel thereto and parallel to itself. The further details of the gripping tool itself are to be discussed further below in connection with FIG. 12. At this point, it should merely be noted that, in all the configurations referred to, the gripping tool is rotatably mounted and is coupled to a corresponding rotary drive and serves as a winding core for the adhesive-side protective strip 8 grasped at the end. For this purpose, the gripping tool is rotatably mounted in an angular gear mechanism 54 arranged laterally offset alongside the deflection rollers 37a and 37b, from which said gripping tool protrudes axially freely. The gripping tool can be specifically set in rotation for winding up by means of the drive motor 55 and the angular gear mechanism.

In the case of the exemplary embodiment that is represented, the drive block of the gripping tool comprising the angular gear mechanism 54 and the motor 55 is coupled by means of parallelogram links 56 to a carriage 59, so that the drive block or the long-nose pliers can be displaced in a translatory manner on an arc of a circle from the starting position, represented in FIGS. 2 and 3 and indicated by dashed-dotted lines in FIG. 4, into the working position, shown by solid lines in FIG. 4. In the starting position, the long-nose pliers lie with their center on the level of the take-up plane 21 of the application tool. By contrast, after transfer into their working position, the long-nose pliers are located in a working plane beneath the take-up plane 21. For displacing the drive block or the long-nose pliers from the starting position into the working position, and vice versa, a pivoting drive 57 is provided in the form of a working cylinder, which in the case of the exemplary embodiment represented connects two diagonally opposite articulation points of the four-bar linkage which is defined by the two parallelogram links 56 or their joints. The carriage 59 is movably guided parallel to the take-up plane 21 on guide rods 60. By means of a displacing drive fastened to the application tool, for example in the form of a working cylinder of which the drive rod is coupled to the carriage 59, the carriage or the long-nose pliers can be displaced parallel to the working plane 21. The displacement path of the carriage 59 corresponds at least to the usable length L of the lacquer film blank 6 that is to be applied.

As far as the position of the gripping tool or the long-nose pliers with respect to the spatial depth in relation to the plane of the drawing of the various representations of the application tool is concerned, it should be noted that the gripping tool lies in the same region in which the already mentioned deflection rollers 37a, 37b and the piece 76 of the adhesive strip tentered by them lie. In the same region there is also the doctor knife 39 described further below, which is carried by a separate carriage 42 and with which the tentered piece 76 of the adhesive strip is doctor-bladed to the film composite 5 presented when it is taken up and with which the lacquer film is doctor-bladed to the bodywork when it is applied. The drive block 54/55 for rotating the gripping tool must therefore lie in a plane on the far side of the gripping tool, deflection rollers, film composite and carriage 42.

In principle, it would also be conceivable to displace the movable gripping tool only linearly within the working plane for grasping the end of the adhesive-side protective strip and for pulling off the same from the film composite—apart from changing the gripping tool from the starting position into the working plane—and to dispense with a complex rotary drive of the gripping tool. However, at least with the desire for a tool-integrated, application-simultaneous pulling-off of the protective strip, this would presuppose that the linear stroke of the gripping tool guided in such a way corresponds at least to twice the length L of the latter film blank that is to be applied; furthermore, the gripping tool guided in such a way would have to be driven at twice the speed of the carriage 42, which carries the doctor knife 38/39. This would presuppose a considerable structural length of the application tool, which makes the latter heavy and unwieldy. Therefore, in the exemplary embodiment represented, the movably mounted gripping tool is—as stated—formed at the same time as a winding device, so that it can be moved at the same speed as the doctor knife 38/39, but nevertheless allows the adhesive-side protective strip to be pulled off from the lacquer film application-simultaneously.

To be specified as a further structural component of the application tools 20, 20′ or 20″ that is important for the method is the already mentioned doctor knife 38, 39, which comes into action both when the film composite is taken up and in the actual application phase. It is movably arranged in two respects and is provided with a corresponding displacement drive. On the one hand, the doctor knife can be displaced with its working edge out of a waiting position represented in FIGS. 2, 3 and 4, in which it is away from the take-up plane 21, into a working position shown in FIG. 5, in which it is close to the take-up plane 21, and in the working position can be pressed with a specific force onto the base 27 (taking up) or onto the bodywork part 3 or 4 to which the lacquer film is to be applied. In order on the one hand to be able to realize a high linear pressure that is as uniform as possible over the entire width of the doctor knife and in spite of slightly curved bodywork surfaces not leave any impressions on the lacquer film to be applied, the doctor-knife blade 39 comprises a blunt and angular ending hard felt of approximately 10 to 20 mm thickness and a density or a weight per volume of approximately 0.6 g/cm3.

In order that, irrespective of a tool-side positioning in relation to the bodywork part, the doctor-knife blade is able unforcibly to follow the transverse inclination of the latter, the doctor-knife blade 39 is pivotably mounted in the doctor-knife holder 38 in two respects, which is indicated in more detail in FIG. 7. The part of the pivotable mount that is important or central in the case of the exemplary embodiment represented there is a take-up fork 65, which is fitted—with the interposition of a thrust bearing collar 63—with a rear bearing pin 62 in an exact-fit bearing bore of the doctor-knife holder 38, thereby forming a first pivoting axis 61, which lies parallel to the infeed direction of the doctor knife and permits pivoting of the doctor-knife blade in the sense of a rolling motion. On the upper side, the take-up fork is supported by means of an interposed elastic medium 64, for example a pair of springs or a piece of elastic foam, on the doctor-knife holder 38, whereby the take-up fork is returned into the neutral position from a deflected position of its own accord. Pivotably fitted in the forked part of the take-up fork is the doctor-knife blade 39, surrounded by a reinforcing plate 39′. For this purpose, said unit 39, 39′ is perforated in the center and provided with a bearing bush 75. At a corresponding location of the take-up fork, a bearing pin is fitted in a fixed manner, so that the doctor-knife blade can pivot about the second pivoting axis 74 created in this way in the sense of a yawing motion. Within the take-up fork, a clearance is left between the rear edge of the doctor-knife blade and the base of the forking, not only allowing a pivoting movement but also receiving an elastic medium 58, for example in the form of a pair of springs or a block of elastic foam, with the aid of which the doctor-knife blade can be returned into the neutral position from a deflected position of its own accord.

For adjusting the doctor knife, the carriage-like doctor-knife holder 38 is displaceably mounted on a carriage guide 40, which is inclined in relation to the take-up plane 21, and is provided with a corresponding adjusting drive 41 in the form of a working cylinder, which also applies the pressing force of the doctor knife. On the other hand, in the working position, the doctor knife can be displaced in a rectilinear manner and parallel to the take-up plane 21. In order to permit this, in the case of the exemplary embodiment represented, the carriage guide 40 is for its part arranged on the already mentioned carriage 42. The displacing drive 43 allows the carriage or the doctor knife 39 to be displaced parallel to the working plane 21, it being possible for a doctor-blading operation to be performed with a specific linear pressure.

Before discussing the application method and the mode of operation of the application tool, an auxiliary device, which is arranged in a stationary manner alongside the base 27 or the suction box 19 for the preparation of a film composite to be taken up and is intended for the specific detachment only of the adhesive-side protective strip from the film composite taken up in the application tool, is to be explained with respect to its construction. In order to understand that such an auxiliary device is very expedient in the present case, it should on the one hand be recalled that the taken-up lacquer film blank 6 of the film composite adheres with only a moderate adhesive force to a piece 76 of the adhesive strip 31 that is stretched in the working plane 21 of the application tool. On the opposite side of the lacquer film blank, the protective strip 8 adheres to the adhesive side of the lacquer film blank, it being possible under some circumstances for this adhesive force to be greater than the adhesive force of the adhesive strip on the visible side of the lacquer film blank in spite of an anti-adhesive coating on the protective strip, especially since the adhesive strip is to be used repeatedly and the adhesive force thereby subsides from time to time. With the auxiliary device it is therefore intended to ensure that, when the tab 10 is pulled off from the taken-up film composite, only the adhesive-side protective strip 8 is detached from the taken-up lacquer film blank and the latter in every case remains adhering to the adhesive strip 31.

The auxiliary device for the specific pulling-off of the adhesive-side protective strip substantially comprises a movable counterstay tongue 46, which is mounted at a vertical distance from the base 27 and parallel to it. It is fastened by one end at the top to a vertical holder 47 and is mounted in a horizontally pivotable manner. By means of a pivoting drive (not represented), it can be pivoted out of the rest position, shown in FIG. 1 in solid lines and located alongside the suction box, by 180° into a working position, lying above the suction box and indicated by dashed-dotted lines. For the sake of completeness, it should be mentioned that a change of position from the rest position into the working position can also be achieved by a displaceable bearing and mounting of the counterstay tongue. In principle, although the auxiliary device for the specific pulling-off of the adhesive-side protective strip could be arranged in a stationary manner anywhere else within the working region of the application robot, the arrangement in the way depicted and described, i.e. in the direct vicinity of the base 27, appears to be advantageous to the extent that no unnecessary paths have to be covered by the application tool and no movement times have to be wasted. In the case of the exemplary embodiment represented, the vertical holder 47 of the auxiliary device is for its part fastened on a carriage 48, which is guided on a carriage guide which is aligned parallel to the longitudinal extent of the base 27. The carriage is drawn into the starting position, represented in the figures, by a restoring spring 49. One important requirement is that, in the working position of the counterstay tongue, a rounded edge comes to lie transversely in relation to the longitudinal extent of the film composite 5, 5′. Furthermore, in the starting position of the counterstay tongue determined by adjustable stops, its rounded edge must be located in approximately the same position in relation to the individual lacquer film blank 6 turned toward the tab 10, 10′, or somewhat in front of it. With respect to the vertical position of the counterstay tongue, it is important that it is located at a small distance beneath the film composite taken up in the application tool and lifted off from the base.

When the adhesive-side protective strip 8 is pulled off by the tool-integrated, movable gripping tool 50, the protective strip is pulled over the rounded edge of the counterstay tongue 46, as represented in an enlarged form in the lower part of FIG. 4. On account of a certain resistance, determined by the tension of the spring 49, against which the counterstay tongue 46 gives way parallel to the longitudinal extent of the base 27, the protective strip 8 to be pulled off is kept under tensile stress and, as a result, a tight radius of curvature r is imparted on it (8) at the point of deflection in the region of the transverse edge of the tongue. This tight bending away of the protective strip 8 achieves the effect that only the latter is detached from the taken-up lacquer film blank, whereas the latter remains securely adhering to the adhesive strip 31. Since the beginning of the detachment of the protective strip from the lacquer film blank is reliably accomplished by means of the stationary auxiliary device, the further pulling-off of the protective strip need no longer take place with the support of the counterstay tongue. Rather, the further pulling-off can take place by means of the tool-integrated, movable gripping tool 50 alone.

In connection with the mode of operation of the application device, it should initially be mentioned that, in preparation for the application of the lacquer film, first the film composite presented by the presentation robot 16 or transfer device 16′ on the base 27 or the suction box 19 has to be taken up in the application tool 20. In the case of the merely two-ply, presented film composite, the bare visible side of the lacquer film blank 6 is freely accessible. For taking up the film composite, the application tool is held with the take-up plane 21 a small distance above the presented film composite and, subsequently, the stretched part 76 of the adhesive strip is doctor-bladed by means of the tool-integrated doctor knife 39 from the position at a distance onto the unyieldingly held film composite, whereby the latter is adhesively attached firmly to the adhesive strip over its full surface area. At this point, it should be mentioned that, even with the stretched piece 76 of the adhesive strip running askew in an undefined manner, the lacquer film blank taken up in the application tool in any case assumes the same defined relative position in relation to the application tool. At the same time as the adhesive attachment of the film blank to the adhesive strip, the movable gripping tool 50 of the tool-integrated pulling-off device also grasps the tab 10 and securely holds it. After the film composite has been taken up in the application tool, the doctor knife returns again into the lifted-off starting position, represented in FIGS. 2 to 4 by solid lines.

During a working cycle, the doctor knife 39 comes into action twice and is moved lengthwise through the application tool 20, 20′ or 20″, that is to say a first time for taking up the film composite in the application tool and a second time for applying the exposed lacquer film blank to the intended bodywork part. In the case of the first doctor knife stroke (taking up), the movable winding device is functionless, whereas it comes into action in the second doctor knife stroke (application) and, during a stroke performed together with the doctor knife, pulls off the adhesive-side protective strip from the lacquer film blank application-simultaneously and winds it up. In the case of all the exemplary embodiments of the application tools that are represented in the figures, two separate carriages are provided, for the doctor knife on the one hand (carriage 42) and the winding device on the other hand (carriage 59), as well as separate actuating cylinders, so that the doctor knives and the winding device can be displaced independently of one another. Accordingly, the suction box shown in FIGS. 2 to 4 stands directly on the table 18.

By contrast, however, the suction box 19′ represented in FIG. 6 is held in a freely suspended manner above the tabletop of the table 18 by means of lateral holding angles, the overall height of the suction box on the one hand being chosen to be so small and the clear distance between the underside of the box and the tabletop on the other hand being chosen to be so great that the gripping tool 50 can be moved in a functionless and unhindering manner away under the suction box during the first doctor knife stroke when it has been lowered beneath the take-up plane 21 of the application tool (state as in FIG. 4). If, therefore, a suction box mounted in a freely suspended manner as shown in FIG. 6 is used, no separate carriages and actuating drives for the doctor knife on the one hand and the movable winding device on the other hand need be provided in the application tool. Rather, both components can be accommodated on one and the same carriage.

For exposing the adhesive side of the lacquer film blank 6, the film composite taken up in the application tool is lifted off from the base 27 up to the height of the counterstay tongue 46. Subsequently, the beginning of the adhesive-side protective strip 8 is detached from the adhesive side of the lacquer film blank initially in a stationary manner by the auxiliary device described above, the adhesive side of the lacquer film blank initially being only partially exposed by winding up. In this partially exposed state of the taken-up lacquer film blank, the counterstay tongue is pivoted back into its rest position, exposing the suction box, and the application tool with the film composite taken up in it is moved to the vehicle body. After the positionally exact alignment of the lacquer film blank over the frame member 3 or 4, the lacquer film blank 6 is doctor-bladed onto the bodywork part to which it is to be adhesively attached, which is securely held in a positionally defined and unyielding manner, from the stretched-out position at a distance by the doctor blade 38, 39 that is longitudinally movable within the application tool. In this case, the further pulling-off of the adhesive-side protective strip or exposing of the adhesive side of the lacquer film blank takes place simultaneously with the doctor-blading in a way corresponding to the progressive advancement of the doctor-blading of the lacquer film blank 6 onto the bodywork part.

For the sake of completeness, it should be mentioned that it would also be conceivable to pull off the adhesive-side protective strip 8 completely from the film composite before the application operation and only then begin to apply the lacquer film. However, with regard to the risk of the pulling-off of the adhesive-side protective strip releasing in the remaining film composite an electrostatic potential which may attract particles from the surroundings onto the exposed, adhesively effective side of the lacquer film 6 and keep them there, it is advisable to keep the time period between pulling-off the effective strip 9 and adhesively attaching the lacquer film 6 onto the bodywork part 1 as short as possible and to carry out only the least possible locational change of the remaining film composite during this time. This aim is best achieved if the adhesive-side protective strip is only pulled off during the application operation, i.e. application-simultaneously.

In order for the applied lacquer film to adhere well and permanently on the vehicle body, the lacquer film blank 6 must be doctor-bladed with a very high linear pressure during the application operation. To be precise, this pressure should be at least 6 N/cm and preferably lie in the range from 7 to 17 N/cm. With such a high linear pressure under the doctor-knife edge, the smallest gas inclusions are progressively pressed out from the adhesive join. Air that is initially adhesively bonded to the exposed layer of adhesive is squeezed out on account of the high linear pressure of the doctor knife. It is also not possible for microfine gas inclusions to join together subsequently to form visible gas bubbles, because—as stated—no gas inclusions remain behind any longer in the adhesive join. When the presented film composite is taken up in the application tool, however, a lower doctor knife pressure than for the application of the lacquer film itself is sufficient.

An important requirement for the application-simultaneous pulling-off of the adhesive-side protective strip 9 is that the lacquer film blank 6 is doctor-bladed onto the bodywork part 1 only in a single direction and with only one doctor knife 38, 39. In this case, an approximately constant distance A—see FIG. 5 or 7—is maintained between the progressively advancing pulling-off point 69 of the protective strip to be pulled off on the one hand and the following, likewise progressively advancing, doctor knife 38, 39 on the other hand. In order to be able to carry this out with a simple and compact application tool, the pulling-off of the adhesive-side protective strip 9 takes place by superposing a translatory linear movement of a winding device on the one hand on the rotary winding movement of the winding device on the other hand. During the winding, the winding device winding up the pulled-off protective strip 8 is moved further in a translatory manner at a speed coinciding approximately with the speed of the doctor knife. Furthermore, the protective strip 8 is pulled off by the winding operation—considered on its own—at a speed corresponding to the circumferential speed of the roll 68, which must be set such that it coincides approximately with the speed of the doctor knife 38, 39, which can take place by corresponding programming of the application robot or of the associated application tool. When displacing the gripping tool working in a winding mode, the setting speed is superposed on the winding speed.

To prevent unacceptably great elongations in the film composite 5, and in particular in the lacquer film blank 6, in particular toward the end of the doctor-blading operation, the deflection roller 37b on the end side is brought up close to the bodywork surface 3, 4 that is to be covered (see FIG. 8). At the same time, the adhesive strip wrapping around the end deflection roller 37b can in this phase be allowed to continue sliding, which can be achieved by slackening of the supply roller 30.

Finally, on account of a pulling-off movement of the application tool 20, in particular the deflection roller 37a on the start side, the upper-side adhesive strip 31 is pulled off from the outside of the completely applied lacquer film blank 6. For this purpose, the application tool 20 is pivoted away from the bodywork surface 3, 4 about a virtual pivoting axis lying in the vicinity of the deflection roller 37b on the end side, as indicated in FIG. 9 by the curved arrow. Instead of or in addition to this, the application tool may be moved in the direction of the end of the lacquer film blank 6 on the inside. On account of one or the other of these movements of the application tool, the deflection roller 37a on the start side pulls off the outer adhesive strip 31, serving as a protective strip, from the lacquer film blank 6 completely applied to the bodywork part, the detachment point 69′ of the adhesive strip shifting in an up to down direction.

One special feature of the lacquer film application to vertical frame members of passenger car side doors is that, once the lacquer film blank has been correctly adhesively bonded onto the flat side of the frame member, its laterally overhanging edges must be folded around and pressed onto the rear side. As long as no robot tool has been provided for this, this can be performed manually in a conventional way, under some circumstances with the assistance of special hand tools for pressing it onto the rear side. Moreover, this activity is less problematical with respect to possible defects, even if carried out manually, since the the main part of the lacquer film is applied in a positionally correct manner and free from bubbles and folds.

An important feature of the present invention is the reuse of the part 76 of the adhesive strip that is stretched in the take-up plane 21, which is only renewed after being used a number of times. Various variants are suitable for this in the case of the exemplary embodiment represented in FIGS. 2 to 5. For example, the piece 76 of the tool-side adhesive strip 31 that is stretched in the take-up plane may be completely renewed at intervals, i.e. after being used a number of times, for example 4 to 6 times. Instead of this, the renewal of said piece of adhesive strip may take place incrementally after each application operation, but only partially each time, in that the piece of adhesive strip 76 that is located in the take-up plane is respectively advanced only by a corresponding fraction of the stretched-out length. For example, the piece of adhesive strip may be incrementally advanced after each application operation by 20% of the stretched-out length, so that after five application operations the piece of adhesive strip located in the take-up plane would be completely renewed.

In this connection, the exemplary embodiment of the application tool 20′ that is represented in FIG. 10, which corresponds with respect to its working phase to the representation in FIG. 2, is to be briefly discussed. With respect to the coincidence of this tool with the application tool 20 as shown in FIGS. 2 to 5, reference can be made to the preceding description. Only in the upper part of the tool 20′ is there a difference from the tool 20. To be precise, in the case of the application tool 20′ as shown in FIG. 10, the supply roller 30, including the compensating roller 70, on the one hand and the take-up roller 33 on the other hand are arranged the other way round with respect to the doctor-blading direction in comparison with the exemplary embodiment represented in FIGS. 2 to 5. This means that the renewal of the adhesive strip takes place in the same direction as the doctor-blading. This has the advantage that, after each partial renewal operation, a new, as yet unused part-length of the piece of adhesive strip 76 is present for each application operation at that end of the film composite at which the tab 10 is located, which is particularly advantageous for the initial specific detachment of the adhesive-side protective strip 8 from the lacquer film blank 6, without the latter becoming detached from the adhesive strip.

At this point, we should also discuss the simple version of the application tool 20″ as shown in FIG. 11, in which a supply roller and a take-up roller are not present at all. Rather, in the case of the application tool 20″, an external exchange of a short piece of adhesive strip 31′ that is stretched in the take-up plane is envisaged. Instead of the deflection rollers 37a and 37b, fixed clamping cylinders 29a and 29b are provided, on the circumferential surfaces of which a clamping device 14 is respectively arranged for clamping the ends of the end piece of adhesive strip 31′ that is to be stretched in the take-up plane. The rear clamping cylinder 29b in the doctor-blading direction is mounted rotatably by a certain angular range and is rotationally prestressed by 9 rotary spring in the sense of stressing the clamped-in piece of adhesive strip (clamping moment 28). Even with such a simplified application tool, the application method according to the invention can be performed, although the piece of adhesive strip 31′ stretched in the take-up plane would have to be exchanged externally, i.e. during a short interruption, after being used a number of times. This somewhat laborious exchange of the adhesive strip would only be acceptable in the case of low numbers of lacquer films to be processed daily.

The sequence for applying the film composite taken up in the robot tool is to be discussed in more detail below with reference to FIGS. 7 to 9, a slightly earlier state, as represented in FIG. 7, being taken as a basis to represent the starting point. In other words, the phases of taking up (FIG. 2) and initially detaching the adhesive-side protective strip 8 from the film composite (FIGS. 3 and 4) have already been completed, i.e. the tab 10 has been grasped by the movable gripping tool 50 and the forwardmost part of the adhesive-side protective strip has already been wound up by the rotatably drivable gripping tool, which is then located in the lowered working plane, to form a small roll 68. The position of the drive block 54/55 at the end of this preparatory phase of the application operation with stationary initial attachment of the protective strip is represented in FIG. 4. Furthermore, the application tool 20 has aligned the film composite that is stretched in the take-up plane 21 in a positionally exact manner at a small distance from the frame member 3 or 4.

Further preparatory pulling-off of the protective strip from the adhesive side of the lacquer film may take place preferably on the path of the application tool to the vehicle body. The winding speed is in this phase made to match the displacing speed of the gripping tool 50 in such a way that the part of the adhesive-side protective strip 8 pulled off from the film composite on the one hand is wound up with a certain density onto the gripping tool and on the other hand a certain initial length of the adhesive side of the lacquer film blank is exposed. During the transfer of the application tool from the table 18, 18′ to the frame member 3, 4 of the side doors, the application tool is pivoted in such a way that the deflection roller 37a on the start side comes to lie on top and the lacquer film can be doctor-bladed from top to bottom, i.e. in a descending manner. This has proved to be advantageous in comparison with an ascending doctor-blading with regard to the concave shape of the bodywork surface in the region of the transition from the frame member to the door side panel.

At the beginning of the actual application phase, the doctor knife 38/39 is lowered in the direction of the arrow from the waiting position, represented in FIG. 4, onto the film composite 5 that is stretched in the take-up plane, the doctor-knife blade 39 of felt coming to rest with its edge in front of the lacquer film blank 6 onto the stretched piece 76 of the adhesive strip—see bottom of FIG. 7. Since the doctor-blading of the lacquer film onto the frame member of the window surround takes place in the vertical and positionally defined supported state of the vehicle side door, the representation in FIGS. 7 to 9 is accordingly chosen in the vertical position. On account of the contact pressure exerted on the doctor knife, the film composite is pressed onto the surface of the frame member 3, 4 to which it is to be applied, the piece of adhesive strip being pressed out in a V-shaped manner from the initially stretched-out position. As this happens, a relative positional change of the beginning of the lacquer film blank 6 must not occur in the longitudinal direction in relation to the frame member 3 or 4. It is therefore advantageous if, during this setting-down phase, the take-up roller 33 is temporarily arrested. Any need for adhesive strip to compensate for the V-shaped spreading of the piece 76 stretched in the take-up plane is then obtained exclusively from the supply roller 30 or the compensating roller. Starting from the starting position of the doctor knife 39 that is represented in FIG. 7, said doctor knife is then guided along the film composite within the application tool under strong contact pressure, the application tool remaining fixed in place over the bodywork part in the longitudinal direction of the lacquer film blank.

During the doctor-blading of the lacquer film onto the bodywork surface, the gripping tool 50 driven in winding mode is advanced in a translatory manner, running ahead at the same speed as the doctor knife and with a constant distance A from the doctor knife. At the same time, the gripping tool is driven at such a winding speed that the adhesive-side protective strip 8 detached from the lacquer film at the progressively advancing detachment point 69 is continuously wound up to form a roll 68. As this happens, the circumferential speed of the roll is approximately, i.e. on average, equal to the translating speed of the doctor knife. In the region of the progressively advancing detachment point 69, the film composite 5 is supported by the roll 68, which is becoming larger.

The end of the doctor-blading operation is represented in FIG. 8. The doctor knife 39 has reached the end of the lacquer film blank 6 and the then already very large roll 68 of the adhesive-side protective strip is already located outside the bodywork part. The deflection roller 37b on the end side has been brought up close to the bodywork part toward the end of the doctor-blading operation, in order not to allow the angle of the remaining piece of the film composite to become too great with respect to the take-up plane 21. If need be, if the tensile stress increases excessively, the adhesive strip continues to slide of its own accord from the supply roller.

At the stage of the application operation that is shown in FIG. 9, the lacquer film 6 is already adhesively attached completely on the bodywork part 3 or 4 and the adhesive-side protective strip has been pulled off completely from the lacquer film and wound up to form a roll 68. All that remains is for the piece 76 of the adhesive strip that is stretched between the deflection rollers 37a and 37b to be pulled off from the outside of the applied lacquer film 6. This pulling-off takes place by a broad pivoting movement of the application tool away from the bodywork part, the detachment point 69′ of the adhesive strip running from one end of the lacquer film to the other. In FIG. 9, the pulling-off of the adhesive strip takes place by a broad movement of the deflection roller 37a on the start side. However, it is similarly conceivable for the adhesive strip to be taken forward by a scooping movement of the deflection roller on the end side.

After the pulling-off of the adhesive strip, it is moved further by a certain fraction of the stretched-out length, whereas the wound-up adhesive-side protective strip 8 is discarded by means of a waste container. For discarding the adhesive-side protective strip wound-up on the gripping tool, the application tool must be brought into such a position that the gripping tool 50 is aligned approximately parallel to the direction of gravitational force and points downward with its free end, so that, after opening the gripping tool, the loosened roll 68 can fall axially off the winding core as a result of gravitational force.

Because of its practical significance for the application technique, the already repeatedly mentioned gripping tool is shown in an exemplary embodiment in FIG. 12 and is to be described in more detail below. The gripping tool 50 that is represented is formed as movably guided and rotatable long-nose pliers, which have an upper (51) and a lower nose part 52, which are in each case formed of constant cross section over their longitudinal extent. The upper nose part is designed in the form of a channel in cross section, the two side edges together defining a bearing plane 53 of the upper nose part. The lower nose part enters radially between these side edges when the long-nose pliers close.

In the ready-to-receive starting position, the long-nose pliers 51/52 must be in such an embracing position, and the rotary drive must be equipped with a correspondingly suitable control for automatically bringing about this embracing position, in which the upper nose part 51 is arranged above the take-up plane 21, whereas the lower nose part 52 is located in the ready-to-receive starting position beneath the take-up plane 21.

In the case of the exemplary embodiment of the gripping tool that is represented in FIG. 12, a symmetrical actuation of the two nose parts 51 and 52 by means of a scissors-type construction is provided. For this purpose, the two nose parts respectively have on their part protruding in the driven winding shaft 77 a sliding block 79, which forms a one-part and rigid unit with the respective nose part. The two sliding blocks are for their part guided in a slotted link 78 radially in relation to the axis of rotation of the winding shaft, the slotted link being rigidly connected to the winding shaft. The latter is recessed in the manner of a slot over an axial fraction of the length, so that a clearance is created for accommodating an actuating scissors mechanism 82. At the opposite end of the clearance, arranged in the same is a working slotted link 80, which is connected to the actuating ram 66, which for its part can be axially displaced by a lifting cylinder 67 in one direction or the other. Two sliding blocks 81 are radially guided in the working slotted link. The ends of the arms of the scissors mechanism are joinedly connected on either side to the sliding blocks 79 and 81. The central point of articulation of the two arms of the scissors mechanism is guided by means of further sliding blocks in axially running slotted links, so that in all spreading states the actuating scissors mechanism is always kept symmetrical in relation to the axis of rotation of the winding shaft within the clearance. On the basis of such a construction, the two nose parts 51 and 52 of the gripping tool can be opened and closed symmetrically in relation to a central position by axial displacement of the actuating ram 66.

The advantage of the gripping tool 50 as shown in FIG. 12 is that not only itself but also its actuating drive is designed in a structurally relatively simple and robust manner. However, the base 27 or the suction box 19, 19′ must make it structurally possible that, when a film composite is taken up, i.e. in the opened state of the long-nose pliers, the latter can be moved in the longitudinal direction of the presented film composite beyond the suction bar 36 of the holding arm 44. The suction bar must therefore be formed such that it is correspondingly narrow in the vertical direction, i.e. narrower than the clear opening of the opened long-nose pliers.

### LIST OF DESIGNATIONS

1 transporting rack for 2
2 side doors
3 frame members, driver's doors
4 frame members, rear doors
5 film composite, FIG. 13
5′ film composite, FIG. 14
6 lacquer film blank, FIGS. 13 and 14
7 waste piece, lacquer film, FIG. 13
8 adhesive-side protective strip, FIGS. 13 and 14
9 interruption between usable piece and waste piece of 5
10 tab, FIG. 13
10′ tab, FIG. 14
11 delivery container for 5, 5′
12 stack of composites in 111
13 compartments for 5 on 18′
14 clamping device on 29a, b
15 application robot
16 presentation robot
16′ transfer device for 5 on 18′
17 securing stops for 11
18, 18′ presentation table for 5
19, 19′ suction box on 18, 18′
20 application tool, FIGS. 2 to 5
20′ application tool, FIG. 10
20″ application tool, FIG. 11
21 take-up plane in 20, 20′, 20″
22 working side of 20, 20′, 20″
23 rear side of 20, 20′, 20″
24 working arm of 15
25 hand joint of 24
26 suction gripper on 16 for 5
27 base for 5, 5′ on 19
28 clamping moment in 29b (FIG. 11)
29a, 29b clamping cylinders for 31′ (FIG. 11)
30 supply roller
31 adhesive strip
31′ piece of adhesive strip (FIG. 11)
32 brake for 30
33 take-up roller
34 drive shaft
35 drive motor
36 suction bar on 44
37a deflection roller on start side
37b deflection roller on end side
38 doctor-knife holder
39 doctor-knife blade
39′ reinforcing plate for 39
40 adjusting guide for 38, 39
41 adjusting drive
42 doctor-knife carriage
43 displacing and pressing drive for 42
44, 44′ holding arm on 19 for 10, 10′
45 vacuum connection for 19
46 counterstay tongue
47 holder for 46
48 carriage for 47
49 spring for 48
50 gripping tool, formed as long-nose pliers
51 upper nose part
52 lower nose part
53 bearing plane of 51
54 angular gear mechanism
55 drive motor
56 parallelogram links
57 pivoting drive
58 elastic medium for centering 39, 39′ about 74
59 carriage for winder
60 guide rods
61 first pivoting axis of 39, 39′ (rolling)
62 bearing pin on 65
63 thrust bearing collar
64 elastic medium for centering 65 about 61
65 take-up fork for 39, 39′
66 actuating ram
67 lifting cylinder
68 roll of 8
69 detachment point 8 from 6
69′ detachment point 31 from 6
70 compensating roller
71 guide for 70
72 tension spring for 70
73 bearing pin for 74
74 second pivoting axis of 39 (yawing)
75 bearing bush in 39
76 part of 31 stretched between 37a+37b
77 winding shaft
78 slotted link in 77
79 sliding block on 51, 52
80 working slotted link
81 sliding block
82 actuating scissors mechanism
A distance between detachment point 69 and doctor knife
L usable length of 6
r radius of curvature of the cross section of 46 at the edge

1-27. (canceled)

28. A method for automated application of a self-adhesive lacquer film to a bodywork part securely held in a positionally defined manner using a freely programmable industrial robot provided with an application tool, which lacquer film is presented as a prefabricated, elongated, and multi-ply film composite with a lacquer film blank contained therein in a positionally defined manner in the working region of the industrial robot for taking up by the application tool, in which method an adhesive-side protective strip, provided with a tab attached at the end, is grasped at the tab by means of a tool-integrated pulling-off device, is pulled off from the film blank that is kept stretched, and its adhesive side is in this way exposed, in which furthermore the lacquer film blank is kept stretched and is aligned in a positionally exact manner over the bodywork part at a small distance from it, and is doctor-bladed onto the bodywork part from the visible side of the lacquer film in the presence of a protective film on the visible side by a tool-integrated, movable doctor knife, the protective film on the visible side subsequently being pulled off from the applied lacquer film,
the method comprising the steps of:
providing a two-ply film composite comprising a lacquer film blank and an adhesive-side protective strip, the film composite having a one tab directly adjacent a usable length (L) of the lacquer film blank;
stretching the film composite so as to be stretched on its own into a planar state, counter to any tendency of the film composite to curl up, on a hard, level base and such that a bare visible side of the lacquer film blank is freely accessible;
using a take-up and protective adhesive strip that is kept stretched in a take-up plane in the application tool at a close distance from the presented film composite, to take up the film composite held in the take-up plane, in that the adhesive strip being doctor-bladed as a take-up medium onto the exposed rear side of the film composite by a tool-integrated doctor knife;
applying the lacquer film blank of the film composite by doctor-blading to the bodywork part after exposing the adhesive side of the lacquer film blank, the adhesive strip being used as a protective strip; and
subsequently, pulling off the take-up and protective adhesive strip, from the applied lacquer film and while leaving the adhesive strip in the application tool for renewed use in a subsequent application operation.

29. The method of claim 28, comprising the further step of using a vacuum to secure clamping of the film composite to counteract a tendency to curl up.

30. The method of claim 28 comprising the further step of renewing the take-up and protective strip after a pre-selected number of uses as a take-up strip.

31. The method of claim 28, comprising the further steps of storing the take-up and protective strip in a roll, deflecting the take-up and protective strip by a deflection roller into the take-up plane and collecting the take-up and protective strip, after use, in the application tool.

32. The method of claim 31, comprising the further step of deflecting the take-up and protective strip from the roll into the take-up plane incrementally after each application operation, and partially after each application operation.

33. The method of claim 32, wherein the take-up and protective strip is incrementally advanced in a same direction relative to motion of the doctor knife.

34. The method of claim 28, wherein, at the beginning of an application operation, partially pulling off the adhesive-side protective strip and partially exposing the adhesive side of the lacquer film blank, and further pulling-off of the adhesive-side protective strip and exposing of the adhesive side of the lacquer film blank, simultaneously during a progressive advancement of the doctor-blading of the lacquer film blank onto the bodywork part.

35. The method of claim 28, comprising the further step of initially pulling off the adhesive-side protective strip from the adhesive side of the lacquer film blank in a stationary manner while forming a tight radius of curvature (r) on the adhesive-side protective strip by using a movable tongue as a counter stay.

36. The method of claim 28, wherein the lacquer film blank is doctor-bladed onto the bodywork part in a single direction and with using a single doctor knife.

37. The method of claim 28, wherein, during the doctor-blading, maintaining a constant distance (A) between a progressively advancing doctor knife and a likewise progressively advancing pulling-off point of the adhesive-side protective strip to be pulled off.

38. The method of claim 28, wherein the step of pulling the adhesive-side protective strip is carried out by using a translating movement of a winding device, winding up the adhesive-side protective strip while moving the strip at a speed coinciding with the speed of the doctor knife, and a winding movement of the winding device winding up the pulled-off protective strip at a speed set to match the speed of the doctor knife.

39. The method of claim 28, wherein an end of the take-up and protective adhesive strip stretched in the take-up plane of the application tool which the doctor knife approaches toward at the end of a doctor-blading operation, is arranged and configured closely adjacent to the bodywork surface to be covered.

40. The method of claim 28, wherein an end of the take-up and protective adhesive strip stretched in the take-up plane of the application tool which the doctor knife (39) approaches toward at the end of a doctor-blading operation, is allowed to continue sliding toward the end of the doctor-blading operation.

41. The method of claim 28, wherein the doctor-blading operation is carried out with a linear pressure of at least 6 N/cm.

42. The method of claim 28, wherein the doctor-blading operation is carried out with a linear pressure in the approximate intensity range of 7 to 17 N/cm.

43. The method of claim 28, wherein the step of pulling off the take-up and protective adhesive strip stretched in the take-up plane, from the completely applied lacquer film blank is carried out by pivoting the application tool away from the bodywork surface about a virtual pivoting axis lying in a vicinity of an end of the adhesive strip.

44. The method of claim 43 wherein the end is on a side of the adhesive strip at the beginning of an application operation piece.

45. A device for automated application of self-adhesive lacquer film to a bodywork part securely held in a positionally defined manner, the lacquer film being presented as a prefabricated, elongated, and multi-ply film composite with a lacquer film blank contained therein in a positionally defined manner in at a working region of an industrial robot for taking up by an application tool, which comprises:
a programmable industrial robot for handling the application tool;
the application tool having a flat, working side base defining a take-up plane formed by two holding elements for the film composite arranged at a distance from each other, with which the latter is kept stretched and, in the stretched state for handling by the industrial robot;
a parallel-displaceable gripping tool for the purpose of grasping a tab of the film composite, for the purpose of pulling off an adhesive-side protective strip from the film composite;
a doctor knife, arranged and configured to be displaced with its working edge out of a waiting position, away from the take-up plane, into a working position, in close proximity to the take-up plane, and to be pressed on with a specific force and, in the working position, can be displaced in a rectilinear manner and parallel to the take-up plane, for performing steps for applying to the bodywork part, a two-ply film composite comprising the lacquer film and an adhesive-side protective strip, having one tab, directly adjacent a usable length (L) of the lacquer film, a hard, level base arranged for providing for the purpose of presenting the film composite in the working region of the industrial robot, clamped in a planar state, counter to any tendency to curl up, and in that the two holding elements of the application tool, arranged at a distance and forming the take-up plane, are formed as deflection rollers; and
an adhesive strip, stored on a brakable supply roller within the application tool, is led away under tensile stress and is guided to a rotatably drivable take-up roller, likewise arranged within the application tool, for taking up the film composite in the application tool.

46. The device of claim 45, wherein the level, hard base comprises a suction box.

47. The device of claim 45, further comprising a supporting arm, protruding from a base for the presentation of the film composite to securely hold a tab at an outermost end to support the tab on an upper side and underside and at sides in a manner such that it the tab is in a position to be grasped by the parallel-displaceable gripping tool.

48. The device of claim 47, wherein the supply roller is arranged on a side of the take-up and protective adhesive strip on which a doctor-knife movement begins.

49. The device of claim 45, further comprising:
a counter-stay tongue arranged adjacent the base for the presentation of the film composite, and being secured at a vertical distance from the base and parallel to the base and being displaceable relative to the base and is also displaceably guided parallel to a longitudinal extent of the base against a specific resistance;
the counter-stay tongue being moved out of a rest position, away from the base, into a working position above the base, the counter-stay tongue having a rounded edge arranged to lie transversely in relation to a longitudinal extent of the film composite and proximate to an end edge of the film composite that is toward a tab of an adhesive side protective strip;
the adhesive-side protective strip being be pulled off over the rounded edge of the counter-stay tongue by the gripping tool, the counter-stay tongue being displaceable against the specific resistance, parallel to the longitudinal extent of the base.

50. The device of claim 45, wherein the gripping tool is rotatably mounted and formed such that it is rotatably drivable and is arranged to have, over a longitudinal extent, an approximately constant cross section, of approximating round shape, in a manner such that the gripping tool is useable as a winding core for an adhesive-side protective strip comprising a strip-shaped material gripped at an end by the gripping tool.

51. The device of claim 50, wherein the gripping tool is formed as long-nose pliers movable within the application tool and having an upper nose part arranged above the take-up plane and a lower nose part, arranged beneath the take-up plane.

52. The device of claim 50, wherein the rotatably drivable gripping tool, when being used as a winding core, is movable at the beginning of each application operation into such a rotational position that the gripping tool is positioned with a take-up surface ready to receive parallel to a tab of the film composite.

53. The device as claimed of claim 50, further comprising a rotary drive of the gripping tool, for operating the gripping tool as a winding core, is arranged to be controlled during a winding operation such that, with respect to rotational speed, irrespective of an increasing diameter of a roll of the adhesive-side protective strip, a predetermined and approximately constant, circumferential speed of the roll is maintained.

54. The device of claim 45, wherein, in a working position, during application, the doctor knife and the gripping tool are in a fixed relation to one another in a longitudinal direction (distance A) and can be displaced at a fixed speed.

55. The device of claim 45, wherein the doctor knife comprises a felt of approximately 10 to 20 mm thickness and a density of 0.6 g/cm³±10%.

56. A method for applying a self-adhesive lacquer film blank to a bodywork part, comprising the step of:
using an adhesive strip maintained in a stretched condition, for the automated application of the self-adhesive lacquer film blank to the bodywork part, to take up the lacquer film blank from a base and as an outer protective strip when the lacquer film blank is pressed onto the bodywork part.
